(19) United States
(12) Patent Application Publication
(10) Pub. No.: US 2025/0225976 A1
(43) Pub. Date: Jul. 10, 2025

(54) Interactive Modification of Speaking Style of Synthesized Speech

(71) Applicant: Cerence Operating Company, Burlington, MA (US)

(72) Inventors: Skjalg Lepsoy, Torino (IT); Matteo Testa, Torino (IT); Jürgen Van De Walle, Merelbeke (BE)

(21) Appl. No.: 18/853,471

(22) PCT Filed: Apr. 25, 2023
(86) PCT No.: PCT/US2023/019757

§ 371 Date: Oct. 2, 2024

Related U.S. Application Data
(60) Provisional application No. 63/338,241, filed on May 4, 2022.

(51) Int. Cl. G10L 13/033; G06F 3/0484; G10L 13/08

(52) U.S. Cl. CPC G10L 13/0335; G10L 13/08; G06F 3/0484

(57) ABSTRACT

Control over speaking style of a text-to-speech (TTS) system is provided without necessarily requiring that the training of the TTS conversion process (e.g., the ANN used for the conversion) take into account the speaking styles of the training data. For example, the TTS system may allow adjustment of characteristics of speaking styles, such as, speed, perceivable degree of “kindness”, average pitch, pitch variation, and duration of pauses. In some examples, a voice designer may have a number of independent controls that vary corresponding characteristics without necessarily varying others. Once the designer has configured a desired overall speaking style based on those controllable characteristics, the TTS system can be configured to use that speaking style for deployments of the TTS system. For example, the TTS system may be used for audio output in a voice assistant, for instance, for an in-vehicle voice assistant.

### CROSS-REFERENCE TO RELATED APPLICATIONS

This application claims the benefit of U.S. Provisional Application No. 63/338,241, filed on May 4, 2022, which is incorporated herein by reference.

### BACKGROUND OF THE INVENTION

This invention relates to speech synthesis, and more particularly to interactive modification of the speaking style of a speech synthesis system.

Speech synthesis, also referred to as text-to-speech (TTS) conversion, involves receiving a representation of the text input to be spoken (i.e., synthesized), for example, in the form of a sequence of words or subword units, and converting that input representation to representation of an audio output, for example, in the form of an audio waveform or as a time-frequency energy representation (“spectrogram”) for presentation to a listener to convey the input text. A variety of approaches can be used, including techniques that rely on training data that includes paired representation of text input and corresponding audio output that are used to determine values of configuration parameters of (i.e., to “train”) a parameterized transformation. For example, artificial neural networks (ANNs) may be used as the parameterized transformation to perform the text-to-speech conversion. In some implementations, if all the training data is from a single speaker that have a particular speaking style, the resulting TTS system will exhibit that same speaking style.

Some approaches make use of training data that includes subsets in different speaking styles and/or from different speakers. Some approaches use a representation of each subset to allow selection of the representation of one of those styles or speakers when a text is to be transformed, for example, by providing an additional input to the conversion processes. That is, the input to the conversion process comprises the representation of the text to be converted and the representation of the speaker or style to be reproduced (i.e., copied or “cloned”). Some approaches permit analysis of a new sample of speech that is not in the training data in order to determine a representation of that new sample for use in TTS conversion.

Control of specific aspects of style of synthesized speech have been proposed, for example, to control prosodic qualities such a variation in pitch, energy, and speed, by explicitly accounting for such characteristics at the time of training of the parameterized transformation.

### SUMMARY OF THE INVENTION

In a general aspect, approaches described herein provide control over speaking style of a TTS system without necessarily requiring that the training of the TTS conversion process (e.g., the ANN used for the conversion) take into account the speaking styles of the training data. For example, the TTS system may allow adjustment of characteristics of speaking styles, such as, speed, perceivable degree of “kindness”, average pitch, pitch variation, and duration of pauses. In some examples, a voice designer may have a number of independent controls that vary corresponding characteristics without necessarily varying others. Once the designer has configured a desired overall speaking style based on those controllable characteristics, the TTS system can be configured to use that speaking style for deployments of the TTS system. For example, the TTS system may be used for audio output in a voice assistant, for instance, for an in-vehicle voice assistant.

Approaches described herein provide advantages over prior techniques. Firstly, there a continuum of style is achievable rather than requiring selection from a set of styles represented in the TTS training data. Secondly, the voice designer is able to adjust styles interactively until the style comes close to what is desired, without the need for further audio recordings or training of the TTS system. Thirdly, the style obtained by the voice designer can be constrained to remain near the distribution of styles contained in the training set, meaning that the tuned speech output will still sound natural. For example, an increase in speed may lead to a decrease in precision of pronunciation to the same degree as that displayed by a human speaker.

In one aspect, in general, a method for configuring a speaking style for a voice synthesis (also referred to as a “text-to-speech” (TTS)) system includes configuring a summarizing unit and a synthesizing unit according to values of a plurality of configurable parameters. For instance, these configurable parameters are determined from a first set of training items, each item comprising a text representation and a corresponding audio representation. Such determining may be referred to as “training” the summarizing and synthesizing units. An advantage of separating this training from other steps is that the first set of training items is not necessarily retained, and the configurable parameters may be kept fixed.

A second set of training items is used to determine a style summary for each item as an output of the summarizing unit for an audio representation the training item, and to determine a plurality of measurements of the training item as outputs of a measurement unit, each measurement being a function of at least one of a text representation of the item and an audio representation of said item. The second set of training items may be the same as the first set of training items, but may be a separate set, which may be collected even after the training of the summarizing and synthesizing units. Relationships between the measurements and the outputs of the summarization unit are used to determine a style basis.

A plurality of quality targets for the speaking style are accepted, and these quality targets are transformed to yield a target style characterization using the style basis. The voice synthesis system is configured according to the target style characterization. Advantageously, adjusting the speaking style of the output of the voice synthesis system, which is controlled by the quality targets, does not require retraining of the synthesizing unit.

Aspects can include combinations of one or more of the following mutually compatible features.

Each quality target corresponds to a distinct quality of synthesized speech. For instance, the quality targets include at least one quality (or two or more quantities) from a group consisting of pitch, pitch variation, power, and speed.

The style basis is selected such that, with variation of a first quality target, variation of qualities of synthesized speech corresponding to other of the quality targets is minimized.

A range of quality targets that is accepted is limited to correspond to a range in the second training set.

The summarization unit is configured to accept an audio input and to produce a fixed-length representation of said input as a style summary. In some instances, a sequence-to-vector transformation, such as a recurrent neural network (RNN) is used. Advantageously, components of the style summary do not have to have an overt relationships to qualities of speech, even if as a whole such qualities are encoded in the space of possible style summaries.

The method further includes using the configured voice synthesis system to compute a synthesized utterance, and causing presentation of the synthesized utterance to a user. In response to the presentation modification of the quality targets are received from the user. These steps are repeated, for instance, until the user determines that a desired overall voice characteristic has been achieved. Advantageously, when each of the target quality inputs controls a distinct quality in the output speaking style, the user may converge rapidly to a desirable natural speaking style.

Using relationships between the measurements and the outputs of the summarization unit to determine a style basis comprises determining the style basis for use in a computational mapping from quality targets to the style characterizations. For instance, determining the style basis comprises computing a linear (or equivalently affine) mapping from a vector representation of quality targets to a vector representation of a style characterization. Correlations of the measurements and the style characterizations may be used to determine the mapping.

Optionally, transforming the quality targets to a target style characterization using the style basis comprises using a reference style characterization corresponding to a reference style. In this way, the quality targets represent deviations from a reference style. For instance, the reference style may be a style characterization of a voice that has a voice style that is close to style that is desired by the user.

In another aspect, in general, a voice design system comprises a style modification unit for providing a user interface to a user via which the style modification component receives adjustment values from a user and producing a style embedding in response to the adjustment values. The system also includes a synthesizing unit configured to receive a style embedding from the style modification component, and to produce audio signals for presentation to the user according to the style embedding. The style modification unit is configurable with a style basis that is used to transform the adjustment values to produce the style embedding. The style modification unit may optionally be further configurable according to an initial embedding and in such a case the style modification unit produces the system embedding according to the adjustment values relative to the initial embedding.

The voice design system may further include a basis computation unit, configured to determine the style basis using training items. Such determining includes using a representation of a waveform for each item of the training items and a measurement based on at least one of a text representation and a waveform representation of said item to determine the style basis.

Other features and advantages of the invention are apparent from the following description, and from the claims.

### BRIEF DESCRIPTION OF THE DRAWINGS

FIG. 1 is a block diagram of a training system for a parameterized text-to-speech system;

FIG. 2 is a block diagram of a runtime text-to-speech system;

FIG. 3 is a block diagram of a voice design system; and

FIG. 4 is a block diagram of a style basis computation system.

### DETAILED DESCRIPTION

### 1 ANN Training

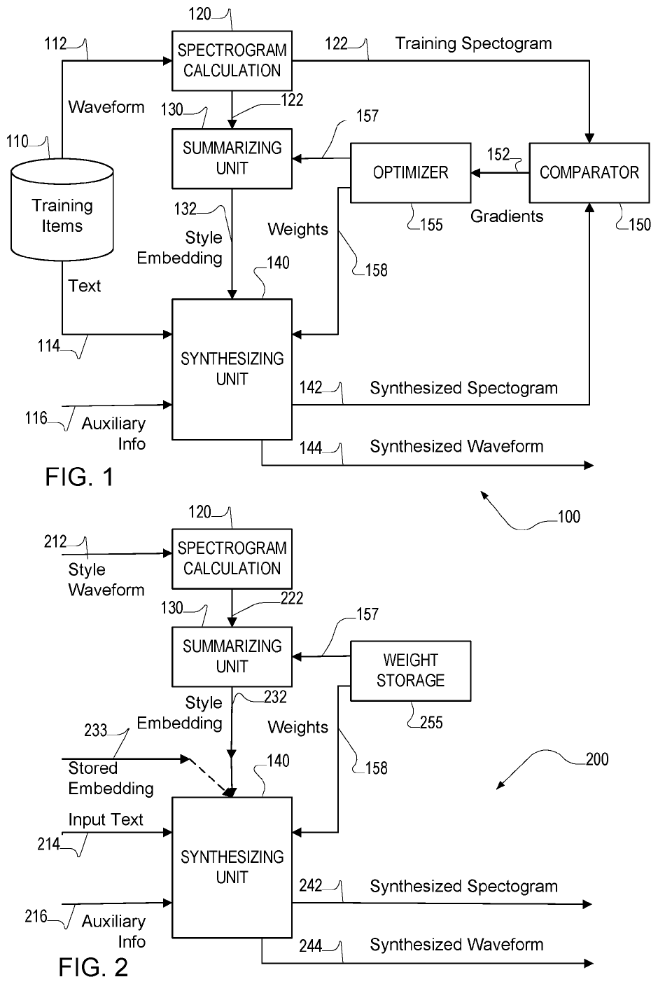

Referring to FIG. 1, a training system 100 for a text-to-speech (TTS) system makes use of a database 110 of training items. Each item comprises a waveform 112 and corresponding text 114. The text may be represented as a phonetic sequence, optionally annotated by prosodic markers. The training system 100 is configured to determine weights 157, 158 that control the manner in which the text is converted to a audio output such as a synthesized waveform 144 and/or a corresponding synthesized spectrogram 142 (i.e., energy as a function to time and frequency). In this training system, the training waveform 112 is converted directly to a spectrogram 122 and a synthesizing unit 140 converts the training text 114 to a synthesized spectrogram 142 corresponding to a synthesized waveform. Operation of the synthesizing unit 140 depends not only on the training text 114, but also on a representation of the training waveform as a whole. A summarizing unit 130 processes the spectrogram 122 for the entire utterance to compute a fixed-length (e.g., numerical) representation of the utterance, which can be referred to as a “style embedding” 132, or referred to equivalently a “style characterization” or “style summary.” During training, the weights 157, 158 are updated by an optimizer 155 according to an output of a comparator 150, which uses a difference between the training spectrogram 122 and the synthesized spectrogram 142 to determine weight gradients 152 (or other updating information) that are used by the optimizer 155 to update the weights 157 for the summarizing unit 130 and the weights 158 for the synthesizing unit. In some implementations, both the summarizing unit 130 and the synthesizing unit 140 are implemented by respective recurrent neural networks (RNNs) that are configured with the respective weights. However, it should be recognized that the particular approaches to determining the style embeddings 132 and the synthesized spectrograms 142 and waveforms 144 are not critical to the style modification approaches described below. In the discussion below, the function of the summarizing unit can be denoted s=S(w) where s is a style embedding corresponding to a waveform w. For completeness, and optional auxiliary input 116 is provided to the synthesizing unit with other conditioning information, such as speaker identity or acoustic parameters (for example, degree of reverberation). Note when such an auxiliary input is provided, the style embedding is expected to train to represent voice characteristics not already represented in the auxiliary input.

With the system trained, the summarizing unit 130 takes a speech spectrogram (or alternatively the waveform directly) as input and produces the embedding 132 as output. This embedding represents a summary of non-phonetic information present in the input waveform and is therefore referred to as a “style” embedding recognizing that it is not strictly limited to representing style.

Referring to FIG. 2, one example of a runtime system 200 uses the weights 157, 158 determined by the training system 100 that are retained in a weight storage 255 and uses those weights to configure the summarizing unit 130 and synthesizing unit 140. To synthesize a new input text 214, that text is provided to the synthesizing unit 140 along with a style embedding to produce a synthesized spectrogram 242 and/or a synthesized waveform 244. One way of determining this style embedding is to use a stored embedding 233 that was retained from the training stage illustrated in FIG. 1, for example, it is a style embedding 132 for one of the training items. The synthesized output is then expected to yield an audio output with the style of the training utterance (or utterances) that produced that stored embedding. Another way of determining the style embedding is to process a waveform 212, referred to as a “style waveform”, which yields a style embedding via the spectrogram calculation 120 and summarizing unit 130 used in the training system 100. Using this style embedding is expected to yield a synthesized output that has characteristics of the style waveform.

### 2 Style Design

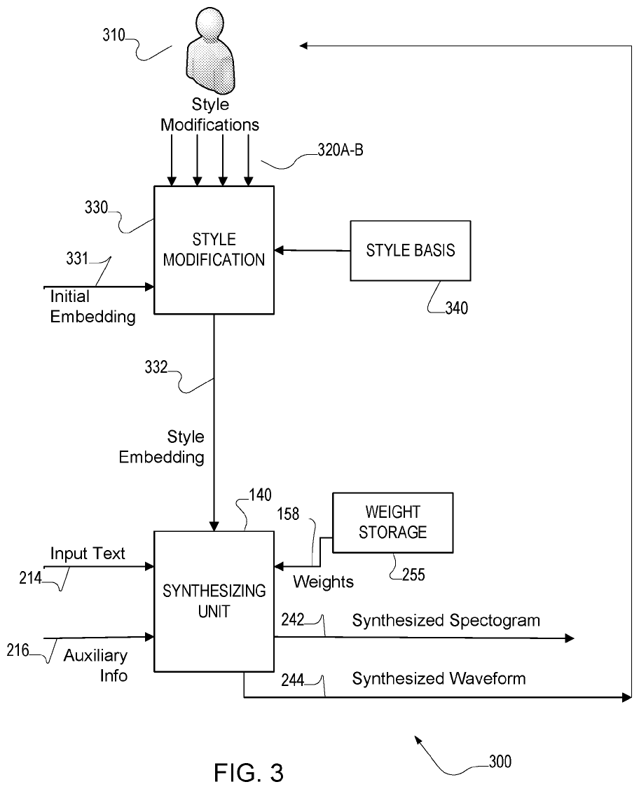

Referring to FIG. 3, an interactive voice design system 300 is used by a voice designer 310 to adjust a style embedding 332, which can then be used as a stored embedding 233 in a runtime synthesis system 200 as illustrated in FIG. 2. The voice designer 310 provides a number of adjustment values 320A-D, each of which is generally associated with a different style characteristic. The voice designer can listen to the synthesized waveform 244 from the synthesizing unit for various input texts 214, and vary the adjustment values 320A-D to achieve a desired overall voice characteristic. A style modification unit 330 processes the adjustment values, and uses data in a style basis 340 to map the adjustment values to a style embedding 332 suitable for use by the synthesizing unit. Optionally, the style modification unit also has an initial embedding 331 relative to which the voice designer 310 makes adjustments. For example, the voice designer may select a “close” speaking style (e.g., as one might select a stored style embedding 233 in FIG. 2) and the adjustments are then made relative to this selected style.

One implementation of the style embedding makes use of a numerical transformation that can be represented in mathematical terms as follows. The adjustment values 320A-D may be represented as a numerical (column) vector t=(t₁, t₂, . . . , t₄)^{T} (e.g., a 4-dimensional vector if there are four separate adjustment values provided by the designer) and the initial embedding 331 may be represented as a vector so. The style basis may be represented as a matrix A=[a₁, . . . , a₄] such that the style embedding used by the synthesizing unit 140 is computed as a matrix product

$$s = {a}_{0} + A t = {a}_{0} + {\sum }_{i = 1 , … , 4} {a}_{i} {t}_{i} .$$

In general, the dimension D of the embedding s is substantially greater than the dimension N of the adjustment vector t.

It should be recognized that the selection of the basis vectors a; can greatly affect how the voice designer adjusts the voice characteristics. One or more approaches to selection of the style basis 340 are described below.

### 3 Style Basis

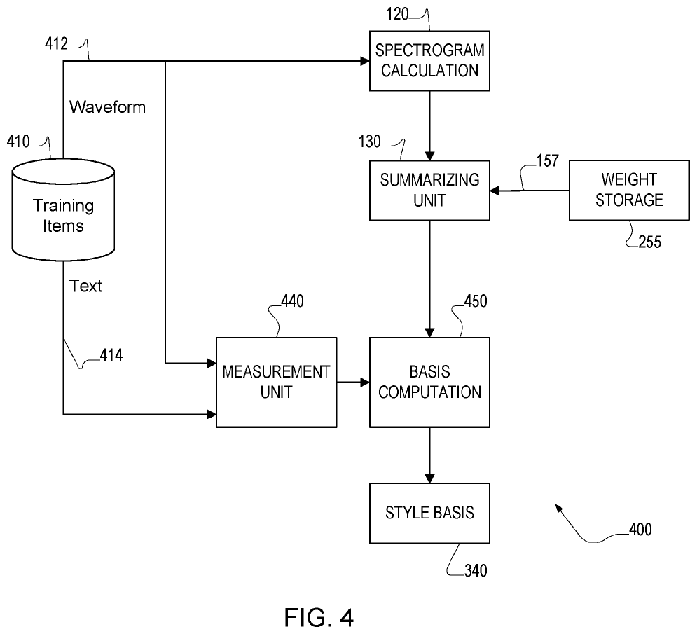

Referring to FIG. 4, the style basis 340 is determined using a style basis computation system 400 from a data set 410 of utterances which may be, but is not necessarily, the same as the utterances used to train the text-to-speech system as illustrated in FIG. 1. In the discussion below, the number of the utterances used to determine the style basis is denoted K, and the waveforms for these utterances are denoted w⁽¹⁾ though w^{(k)} and a corresponding text input (e.g., phoneme sequences) are denoted f⁽¹⁾ though f^{(k)}. Note that these utterances can be determined (e.g., recorded) separately from the training of the synthesizing unit and the summarizing unit, or may be a subset (or the whole) of the training set originally used. Each of these waveforms is processed by the trained summarizing unit 130 to determine a corresponding embedding vector, denoted s⁽¹⁾ though s^{(K)}, each of which may be referred to as a “style summary” of the corresponding waveform. Generally, a basis computation unit 450 processes the pairs of embedding vectors and measurements described below to yield the style basis 340 introduced in FIG. 3.

Approaches described below are based on style modifications that adjust objective qualities of an utterance. In particular, each waveform w^{(k)} of a training utterance, or more generally a combination of the waveform and the text or phoneme sequence (w^{(k)}, f^{(k)}) are processed by a “measurement” unit 440 to compute mᵢ( ) as a scalar quantity representing the amount or degree that the i^{th} quality is present. In general, there are multiple such qualities, and the individual evaluations of the i^{th} quality for the k^{th} utterance can be represented as a vector mᵢ(w^{(k)}, f^{(k)}). The qualities are chosen to be related to speaking styles that a voice designer might want to adjust. As an example, such qualities may be chosen as:
m₁=average pitch (fundamental frequency of voice)
m₂=standard deviation of pitch
m₃=average power
m₄=speed (in terms of duration divided by number of phonemes).

In a first implementation, a voice designer may specify the target values for these qualities, denoted t₁ through t₄. Because the synthesizing unit 140 requires a style embedding 332 to operate, relationships between the tᵢ qualities, and the components of a style embedding s are determined from data, and used to determine the style basis 340 according to which the mapping from qualities to style embedding is performed.

One approach to performing the mapping from qualities to style embedding is as a linear (or more generally affine) transformation of the qualities to the style embedding. Such a transformation can be represented as a matrix calculation s=A*t where t=(1, t₁, . . . , t_{N})^{T} is a target quality vector (augmented with a fixed unit entry for affine transformations), and where A* is a matrix with (N+1) columns and D rows. D being the dimension of the embedding vector s. This can be represented as a summation

$$s = {a}_{0} + {\sum }_{i = 1}^{N} {a}_{i} {t}_{i}$$

where the D-dimensional vectors aᵢ are denoted as the “basis vectors” where A*=[a₀, a₁, . . . , a_{N}], which are provided by the style basis 340 component illustrated in FIG. 3.

One approach to computing the basis vectors (or equivalently the matrix A*) makes use of a computational procedure referred to as a “pseudo-inverse” (also referred to as a Moore-Penrose inverse) based on an assumption that the quality vectors are approximately formed as a matrix multiplication m^{(k)}=As^{(k)}. One way of computing A′ is to arrange the quality vectors a matrix M=[m⁽¹⁾, . . . , m^{(K)}], where each quality vector has the form (1, m₁, . . . , m_{N})^{T} such that M has N+1 rows and K columns, and the corresponding style embeddings are arranged in a corresponding matrix S=[s⁽¹⁾, . . . , s^{(K)}], which has D rows and K columns. The pseudo-inverse is computed as A*=SM^{†}, where M^{†}=M^{T}(MM^{T})⁻¹, which has D rows and N+1 columns. In this way, if measurement m₁ is associated with average pitch, then as the voice designer increase t₁ from zero, the average pitch is expected to increase from the average pitch associated with the initial embedding 331.

A second approach addresses an aspect of the first approach that relates to a relationship between the different measurements. For example, suppose that in the training data, an increase in average pitch resulting from the voice designed increasing t₁ is also associated with an increase pitch variation represented by the second measurements, m₂, or an increase in speaking rate, m₄. The second approach aims to retain the association of the input that are controlled by the voice designer with the underlying measurements, but also aims to avoid the coupling between the inputs. For example, it may be desirable to change the average pitch without modifying the pitch variation or the speaking rate.

The second approach uses a “decorrelating” approach to provide the designer control via a vector of decorrelated source control values q. As in the first approach, providing the values in q is used to yield the style embedding s. As in the first approach, the transformation of q to yield s may be represented as a matrix multiplication: s=C*q.

One computational approach to determining the matrix C* is to perform a decomposition of the (N+1)×K matrix M introduced above using what may be referred to as a “QR-factorization” or “Gram-Schmidt orthogonalization”, which are techniques known in the field of matrix computation. Specifically, the result of such a computation are an (N+1)×(N+1) matrix R and a K×(N+1) matrix Q such that:

M=R^{T}Q^{T}

where Q^{T} has orthonormal rows and R^{T} is lower diagonal. This procedure essentially amounts to computing:

$${q}_{0} = {m}_{0} / ‖ {m}_{0} ‖ ,$$

$${u}_{1} = {m}_{1} \text{··} ( {m}_{1}^{T} {q}_{0} ) {q}_{0} and {q}_{1} = {u}_{1} / ‖ {u}_{1} ‖ ,$$

$$and$$

$${u}_{i} = {m}_{i} - {\sum }_{j < i} ( {m}_{i}^{T} {q}_{j} ) {q}_{j} and {q}_{i} = {u}_{i} / ‖ {u}_{i} ‖ .$$

Having computed Q, the transformation matrix C* is computed as the matrix product:

C*=A*R^{T}.

That is, the target measurements could be determined as t=R^{T}q, and then uses as in the first approach above. However, such intermediate computation is not required by using C* directly.

A third approach addresses an aspect of scale, by which the inputs provided by the voice designer are scaled so that the map to a range that corresponds to the range of speaking styles observed in the training data. For example, this range-setting approach is applied to the second approach by determining the percentile values of the each of the elements of the q vectors determined from the training data. For example, a range of [−1.0,+1.0] of a scaled input value q̅ᵢ may map to a range of the 1^{st} to 99^{th} percentile observed for qᵢ, where the observed q vectors can be computed as q=(R^{T})⁻¹m.

There are yet other ways of “decorrelating” the measurements so that the voice designer can have independent control of different aspects of the speaking style. For example, the ordering of the measurements may affect the association of the individual inputs and the changes in speaking style. Another example using linear transformations is to use an “SVD” transformation of the M matrix to yield a ranked set of components according to their singular values, but in such an approach, the association of the input components with the original measurements may be lost and therefore less directly useful to the voice designer.

Approaches described above make use of linear transformations from measurements to style embeddings. In yet other alternatives, that inverse mapping from target measurements t or decorrelated measurements q to style embeddings may make use of non-linear transformations (e.g., neural networks, non-linear regression and the like) in which the parameters of such transformations may be optimized to match the training data or to correlation data representing a relationship of measurements and style embeddings.

Approaches described above may make use of objective measurements m of the audio and/or text input, subjective measurements (e.g., annotated by human listeners) may be used in a similar manner.

The approaches to incremental adjustment of speaking style may be used in conjunction with a voice “cloning” approach in which the baseline style embedding is determined by summarizing input from a particular speaker, and then adjustments of the cloned speaker are then made using an approach presented above.

The interactive voice design system 300 introduced in FIG. 3 may be implemented with a graphical and audio interface on a design workstation, for example, implemented using stored software on a general purpose computer. The graphical interface may include controls (i.e., sliders and radio buttons) that permit the voice designer to select a baseline speaking style, and continuously adjust to components that affect the separate aspects of the speaking style. The audio interface the provides output of example synthesized utterances according to the controlled style.

While the approaches are described for use at a design time, with the resulting embedding being configured into a runtime system, variants of this approach may provide an end-user the opportunity to modify the speaking style to their own preferences. For example, a vehicle owner may choose a speaking style that they find pleasant, and can essentially perform the exploration of voice styles described above for use by the voice designer.

In some examples, multiple different speaking styles may be selected for different functions, for example to make the styles distinctive to provide cues as to their source (e.g., a navigation system versus and entertainment system) or their urgency (e.g., providing emergency warnings in a different speaking style that entertainment messages).

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

What is claimed is:

1. A method for configuring a speaking style for a voice synthesis system:
configuring a summarizing unit (122) and a synthesizing unit (140) according to values of a plurality of configurable parameters;
processing a second set of training item (410) to determine a style summary for each item as an output of the summarizing unit (130) for an audio representation of the training item, and to determine a plurality of measurements of the training item as outputs of a measurement unit (440), each measurement being a function of at least one of a text representation of the item and an audio representation of said item;
using relationships between the measurements and the outputs of the summarization unit to determine a style basis (340);
accepting a plurality of quality targets for the speaking style;
transforming the quality targets to a target style characterization using the style basis; and
configuring the voice synthesis system according to the target style characterization.

2. The method of claim 1, wherein each quality target corresponds to a distinct quality of synthesized speech.

3. The method of claim 2, wherein the quality targets include at least one quality from a group consisting of pitch, pitch variation, power, and speed.

4. The method of claim 2, wherein the style basis is selected such that, with variation of a first quality target, variation of qualities of synthesized speech corresponding to other of the quality targets is minimized.

5. The method of claim 1, wherein a range of quality targets that is accepted is limited to correspond to a range in the second training set.

6. The method of claim 1, further comprising determining the configurable parameters from a first set of training items (110), each item comprising a text representation and a corresponding audio representation.

7. The method of claim 1, wherein the summarization unit (130) is configured to accept an audio input and to produce a fixed-length representation of said input as a style summary.

8. The method of claim 1, further comprising:
using the configured voice synthesis system to compute a synthesized utterance;
causing presentation of the synthesized utterance to a user;
receiving in response to the presentation modification of the quality targets from the user; and
repeating the steps of computing the synthesized utterance and the causing its presentation and the receiving of the modifications of the quality targets.

9. The method of claim 1, wherein using relationships between the measurements and the outputs of the summarization unit to determine a style basis comprises determining the style basis for use in a computational mapping from quality targets to the style characterizations.

10. The method of claim 9, wherein determining the style basis comprises computing a linear mapping from a vector representation of quality targets to a vector representation of a style characterization.

11. The method of claim 9, further comprising using correlations of the measurements and the style characterizations to determine the mapping.

12. The method of claim 1, wherein transforming the quality targets to a target style characterization using the style basis comprises using a reference style characterization corresponding to a reference style, and wherein the quality targets represent deviations from a reference style.

13. A voice design system (300) comprising:
a style modification unit (330) for providing a user interface to a user (310) via which the style modification component receives adjustment values (320A-B) from a user (310) and producing a style embedding (332) in response to the adjustment values;
a synthesizing unit (140) configured to receive a style embedding (332) from the style modification component, and to produce audio signals for presentation to the user according to the style embedding;
wherein the style modification unit is configurable with a style basis (340) that is used to transform the adjustment values to produce the style embedding.

14. The voice design system of claim 13, wherein the style modification unit is further configurable according to an initial embedding (331) and wherein the style modification unit produces the system embedding according to the adjustment values relative to the initial embedding.

15. The voice design system of claim 13, further comprising:
a basis computation unit (450), configured to determine the style basis (340) using training items (410), including using a representation of a waveform for each item of the training items and a measurement based on at least one of a text representation and a waveform representation of said item to determine the style basis.
